(19) United States
(12) Patent Application Publication
(10) Pub. No.: US 2023/0306756 A1
(43) Pub. Date: Sep. 28, 2023

(54) COMPUTER-IMPLEMENTED METHOD FOR DETERMINING AN EMOTIONAL STATE OF A PERSON IN A MOTOR VEHICLE

(71) Applicant: Dr. Ing. h.c. F. Porsche Aktiengesellschaft, Stuttgart (DE)

(72) Inventors: David Bethge, Stuttgart-Feuerbach (DE); Tobias Große-Puppendahl, Tübingen (DE); Luis Falconeri Sousa Pinto Coelho, Berlin (DE)

(73) Assignee: Dr. Ing. h.c. F. Porsche Aktiengesellschaft, Stuttgart (DE)

(21) Appl. No.: 17/945,172

(22) Filed: Sep. 15, 2022

(30) Foreign Application Priority Data
Mar. 23, 2022 (DE) 10 2022 106 812.9

(51) Int. Cl. G06V 20/59; G06V 20/58; G06V 20/64; G06V 40/16; G06V 10/70

(52) U.S. Cl. CPC G06V 20/597; G06V 20/58; G06V 20/64; G06V 40/174; G06V 10/87

(57) ABSTRACT

A computer-implemented method for determining an emotional state of a person in a motor vehicle. The method includes the following steps: recording (S1) environmental data using environmental sensors of the motor vehicle, the environmental data relating to an environment of the motor vehicle; recognizing (S2) various objects using the environmental data; assigning (S3) the objects to various classes; determining (S4), respectively, a number of the objects assigned to the respective classes; and determining (S5) the emotional state using the numbers and the classes.

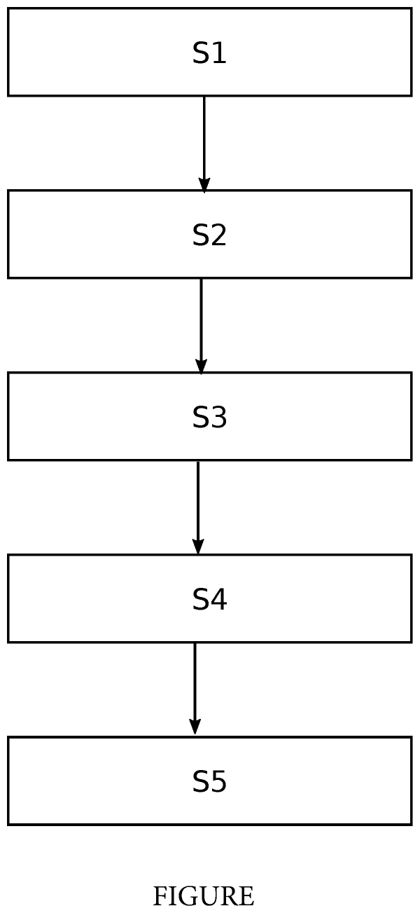

### CROSS-REFERENCE TO RELATED APPLICATION

This application claims priority to German Patent Application No. 10 2022 106 812.9, filed Mar. 23, 2022, the content of such application being incorporated by reference herein in its entirety.

### FIELD OF THE INVENTION

The invention relates to a computer-implemented method for determining an emotional state of a person in a motor vehicle.

### BACKGROUND OF THE INVENTION

US 2019/0377961 A1, which is incorporated by reference herein, discloses a method in which the emotional state of a person in a motor vehicle is determined based on various pieces of vehicle information. The vehicle information used also includes information about the environment of the motor vehicle, which is captured with a camera.

### SUMMARY OF THE INVENTION

Environmental data are recorded using environmental sensors of the motor vehicle. The environmental sensors may comprise cameras, for example. The environmental data relate to an environment of the motor vehicle. For example, the environmental data may comprise images and/or videos. Using the environmental data, various objects are recognized. The objects can thus be located in the environment of the motor vehicle. For example, the objects may be other vehicles, people, traffic lights, and/or traffic signs. For example, the objects may be recognized using artificial intelligence, LIDAR or optical sensor(s) on the vehicle, information available via the Internet (traffic reports, number of traffic lights or stop signs, on route planned), etc.

The objects are assigned to various classes. In addition, a number of the objects associated with the respective class is respectively determined. For example, for each of the classes, the number of respectively associated objects may be determined. The emotional state of the person is determined using the numbers and the classes.

The determined emotional state can be further used in already known methods in order to, for example, point out the emotional state to the user and/or to adjust the lighting and/or sounds in the motor vehicle.

The method is based on the realization that when using the motor vehicle, the environment significantly affects the emotional state of the person. A relatively large number of other vehicles and people outside the motor vehicle can increase the stress of the person and result in an irritated emotional state, while an environment with comparatively few other vehicles and people outside the motor vehicle can have a soothing effect on the person in the motor vehicle.

Another advantage of the method is that due to the relatively large number of reliable environmental data, data directly related to the person in the motor vehicle do not necessarily have to be collected and used. This is in particular advantageous for persons who wish to avoid the collection and storage of such data, or where the collection and storage of such data is prohibited by regulations.

According to one embodiment of the invention, interior data of the motor vehicle may be recorded using internal sensors of the motor vehicle. The emotional state may be determined using the interior data. For example, the interior data may relate to a volume level in a passenger compartment of the motor vehicle, the volume level being recorded using a microphone of the vehicle.

According to one embodiment of the invention, it is possible that no image and/or video data containing information about the face of the person are used to determine the emotional state. This may be desired or required for data protection reasons. This embodiment is made possible by the method steps described above, in particular by the assignment of the objects to various classes and the determination of the respective number of the respectively assigned objects.

According to one embodiment of the invention, the emotional state may be determined solely from the interior data and the environmental data.

According to one embodiment of the invention, the environmental data may comprise image and/or video data. Using artificial intelligence, the objects can thus be recognized particularly well and assigned to the classes.

s According to one embodiment of the invention, the classes may comprise one or more of the following classes: a passenger vehicle class, a people class, a bicycle class, a motorcycle class, a bus class, a commercial vehicle class, a traffic light class, a traffic sign class, a first near-distance class, a second near-distance class, a medium-distance class, a first far-distance class, and a second far-distance class. In this respect, objects that were recognized as a passenger vehicle are assigned to the passenger vehicle class if the latter is provided. Objects that were recognized as a person are assigned to the people class if the latter is present. Objects that were recognized as a bicycle are assigned to the bicycle class if the latter is present. Objects that were recognized as a motorcycle are assigned to the motorcycle class if the latter is present. Objects that were recognized as a bus are assigned to the bus class if the latter is present. Objects that were recognized as a commercial vehicle are assigned to the commercial vehicle class if the latter is present. Objects that were recognized as a traffic light are assigned to the traffic light class if the latter is present. Objects that were recognized as a traffic sign are assigned to the traffic sign class if the latter is present. Objects that have a distance to the motor vehicle that is less than a first threshold value are assigned to the first near-distance class if the latter is present. Objects that have a distance to the motor vehicle that is greater than the first threshold value or equal to the first threshold value and, in both cases, less than a second threshold value are assigned to the second near-distance class if the latter is present. Objects that have a distance to the motor vehicle that is greater than the second threshold value or equal to the second threshold value and, in both cases, less than a third threshold value are assigned to the medium-distance class if the latter is present. Objects that have a distance to the motor vehicle that is greater than the third threshold value or equal to the third threshold value and, in both cases, less than a fourth threshold value are assigned to the first far-distance class if the latter is present. Objects that have a distance to the motor vehicle that is greater than the fourth threshold value or equal to the fourth threshold value and, in both cases, less than a fifth threshold value are assigned to the second far-distance class if the latter is present. Practical experiments have shown that the emotional state can be determined particularly well when using these classes. Image processing and/or artificial intelligence and/or traffic reports may be used to determine the objects.

According to one embodiment of the invention, it is possible that only passenger vehicles that are spaced apart from the motor vehicle counter to a direction of travel of the motor vehicle are assigned to the passenger vehicle class. Practical experiments have shown that passenger vehicles in front of the motor vehicle affect the emotional state less than passenger vehicles behind the motor vehicle. Presumably, some persons feel harassed by passenger vehicles traveling behind the motor vehicle.

The control unit comprises an electronic digital data memory and a signal processing unit. The signal processing unit may be a processor, for example. The data memory stores instructions that can be read and executed by the signal processing unit. The signal processing unit is designed to carry out a method according to one embodiment of the invention when executing the instructions.

The motor vehicle comprises a control unit according to one embodiment of the invention and the environmental sensors. It is also possible for the motor vehicle to comprise the internal sensors.

### BRIEF DESCRIPTION OF THE DRAWINGS

Further features and advantages of the present invention become apparent from the following description of a preferred exemplary embodiment with reference to the appended illustration. Shown is:

The sole FIGURE is a schematic block diagram of a method according to one embodiment of the invention.

### DETAILED DESCRIPTION OF THE INVENTION

Turning now to the FIGURE, in step S1, environmental data of an environment of the motor vehicle are recorded with cameras. The environmental data comprise images and/or videos. In step S2, various objects are recognized in the images and/or videos. These objects may be vehicles, traffic lights, traffic signs, and/or people. The recognition may be carried out using artificial intelligence, for example. The recognized objects are assigned to various classes in step S3. For example, people may be assigned to a people class, vehicles to a vehicle class, traffic lights to a traffic light class, and traffic signs to a traffic sign class. There may also be classes that refer to the distance between the recognized object and the motor vehicle. In step S4, for each class, a number of the objects associated with this class is determined.

The determined numbers and classes are used in step S5 for determining the emotional state of the person in the motor vehicle. For example, a relatively high number (e.g., above a pre-determined threshold value) of vehicles, traffic lights, and traffic signs may result in the person having a high stress level and thus being irritated. A relatively small number of vehicles, traffic lights, and traffic signs may result in the person being relaxed.

The numbers and classes are particularly advantageous for determining the emotional state from the environmental data. Practical experiments have shown that taking pictures and/or videos of the person can be omitted. This may be desired or necessary for data protection reasons, for example.

The determined emotional state can be used to adjust lighting and/or sounds in the motor vehicle. For example, soothing lighting (e.g., low level lighting and/or soothing colors) and soothing sounds may be turned on if it has been determined that the person is irritated. It is also possible for invigorating music to be turned on if it has been determined that the person is relaxed. The decision as to whether the lighting and/or sounds in the motor vehicle are adjusted can also be left to the person. It may then be proposed to the person to have the lighting and/or sounds in the motor vehicle adjusted.

The method may be carried out by a control unit (i.e., computer having a processor, controller, memory, transmitter/receiver, etc) within the vehicle, for example. The control unit can be electrically connected (for control purposes) to the aforementioned systems of the vehicle: e.g., audio system, lighting system, camera(s), interior sensor, exterior sensors (LIDAR or other distance sensors), etc. The control unit may also collect information wirelessly from the Internet. The information may be related to weather, traffic, etc. The driver may pre-program specific songs in the control unit for different emotional states (e.g., classical music for stressful driving scenarios).

The control unit can comprise an electronic digital data memory and a signal processing unit. The data memory stores instructions that can be read and executed by the signal processing unit.

What is claimed is:

1. A computer-implemented method for determining an emotional state of a person in a motor vehicle, said method comprising the steps of:
recording environmental data using environmental sensors of the motor vehicle, the environmental data relating to an environment of the motor vehicle;
recognizing various objects using the environmental data;
assigning the objects to various classes;
determining, respectively, a number of the objects assigned to the respective classes; and
determining the emotional state using the numbers and the classes.

2. The method according to claim 1, wherein interior data of the motor vehicle are recorded using internal sensors of the motor vehicle, wherein the emotional state is determined using the interior data.

3. The method according to claim 1, wherein no image and/or video data containing information about a face of the person are used to determine the emotional state.

4. The method according to claim 1, wherein interior data of the motor vehicle are recorded using internal sensors of the motor vehicle, wherein the emotional state is determined using the interior data, and wherein the emotional state is determined exclusively from the interior data and the environmental data.

5. The method according to claim 1, wherein the environmental data comprise image and/or video data.

6. The method according to claim 1, wherein the classes comprise one or more of the following classes: a passenger vehicle class, a people class, a bicycle class, a motorcycle class, a bus class, a commercial vehicle class, a traffic light class, a traffic sign class, a first near-distance class, a second near-distance class, a medium-distance class, a first far-distance class, and a second far-distance class.

7. The method according to claim 6, wherein only passenger vehicles that are spaced apart from the motor vehicle counter to a direction of travel of the motor vehicle are assigned to the passenger vehicle class.

8. A control unit for a motor vehicle comprising an electronic digital data memory and a signal processing unit, wherein the data memory stores instructions that can be read and executed by the signal processing unit, wherein the signal processing unit, when executing the instructions, is configured to do the following:
record environmental data using environmental sensors of the motor vehicle, the environmental data relating to an environment of the motor vehicle;
recognize various objects using the environmental data;
assign the objects to various classes;
determine, respectively, a number of the objects assigned to the respective classes; and
determine the emotional state using the numbers and the classes.

9. A motor vehicle comprising the control unit according to claim 8 and the environmental sensors.
